(19) United States
(12) Patent Application Publication
(10) Pub. No.: US 2026/0255007 A1
(43) Pub. Date: Aug. 27, 2026

(54) SYSTEM AND METHOD FOR OPTIMIZED DATA DELIVERY OVER HYBRID NETWORKS BASED ON DATA PRIORITY, CACHING, COST, AND DELIVERY SCHEDULE

(71) Applicant: Q'LIGENT CORPORATION, Melbourne, FL (US)

(72) Inventors: Brick Eksten, Uxbridge (CA); Andrey Gaynulin, Nizhny Novgorod (RU)

(21) Appl. No.: 19/532,463

(22) Filed: Feb. 6, 2026

Related U.S. Application Data
(60) Provisional application No. 63/754,920, filed on Feb. 6, 2025.

(51) Int. Cl. H04N 21/262; H04N 21/435; H04N 21/442; H04N 21/647

(52) U.S. Cl. CPC H04N 21/26216; H04N 21/4351; H04N 21/442; H04N 21/64723

(57) ABSTRACT

A system and method for optimizing delivery of data over hybrid networks by generating delivery plans derived from a delivery schedule and optimizing delivery timing, delivery method, and network selection based on data priority, caching availability, delivery cost, and destination reach.

### CROSS REFERENCE TO RELATED APPLICATIONS

The present application claims priority under 35 U.S.C. 119(e) to the provisional patent application filed on Feb. 6, 2025 and assigned application No. 63/754,920. The contents of that application are incorporated herein.

### FIELD OF THE INVENTION

This disclosure relates to a system and method for optimizing delivery of media content (also referred to as data) over hybrid networks based on priority, caching availability, cost, and delivery schedule. The system sets scheduled delivery obligations as defined for distribution endpoints and scheduled playout, not based on individual viewer choice, or “watch anytime” video-on-demand. Receiver side reconstruction, reassembly, and play out are assumed capabilities and are not the subject of this disclosure.

### BACKGROUND OF THE INVENTION

Traditional content distribution systems optimize real-time transport paths to meet play out deadlines, often requiring parallel redundant networks. As distribution shifts to IP based delivery, such approaches introduce unnecessary cost, fragility, and operational complexity.

The current media landscape involves diverse delivery networks including satellite, terrestrial IP, and cellular networks. Traditional data delivery systems struggle to adapt to dynamic conditions of these networks and to optimize the delivery process to achieve low cost and efficiency.

Existing satellite delivery systems, while effective for large-scale distribution, are costly and inflexible. The shift toward mobile media consumption and smart TVs necessitates a more flexible approach aligning with internet-based delivery models.

Existing linear content delivery systems rely on a known level of performance for the network over which the content is delivered. This known performance level could be any combination of propagation time, network congestion, losses, buffering required to overcome congestion and loss, and error correction to overcome performance and loss issues.

In the current OTT (over the top) distribution systems there are a multitude of content variants (e.g., different bitrates and resolutions) that can be applied to the network source content to overcome these local network performance issues. The challenges presented by any given network, force the content owner to make decisions about content delivery parameters, which will impact the cost, timeliness, and quality of the delivered content.

Additionally, these issues are made more complex when delivery must adhere to a delivery schedule. Many forms of content rely on a consumption schedule, that is, the date and time of day that consumers rely on to view the content. The schedule is typically generated prior to delivery, and thus existing delivery systems must optimize delivery paths to meet the schedule by relying on real-time or near-real-time transport of the content through the network. In many situations, this results in expensive redundancy of data delivery paths.

The end-to-end propagation delay starts with the consumption schedule. All systems prior to the delivery end point must modify data processing to accommodate propagation delay. Alternatively, all systems between the source and destination must operate in real-time where the clock at the source and the clock at the destination are closely aligned such that the consumer does not notice the propagation delay. Eliminating or minimizing delay (so that the delay is not noticeable to the consumer) often leads to expensive network topologies with fully redundant network deployments (A/B or Red/Blue networks in industry parlance) that further drive-up costs and network complexity.

In analyzing the delivery schedule, it is apparent that most of the media content does not require delivery via dedicated, expensive, and complex networks to accommodate the occasional content that must be delivered ‘live’ from camera to consumer. A sports network is one such example. Delivery of a live sporting event requires minimal or virtually no propagation delay for the portion of the day during which it is delivered to consumers. But substantial elements of a sports schedule contain content that need not be delivered live to the consumer.

### SUMMARY OF THE INVENTION

The disclosed system generates delivery plans derived from a delivery schedule defining a scheduled time of use at one or more destinations. Delivery timing, delivery method, and network selection are optimized relative to the scheduled time of use, decoupling delivery completion from content consumption.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates a system architecture, including key modules/components and their interactions. Example scenarios showcase the dynamic routing decisions based on various factors.

FIG. 2 illustrates a system architecture, including data analysis and priority assignment processes.

FIG. 3 illustrates yet another system architecture, including a network cost and path evaluation process.

In accordance with common practice, the various described features are not drawn to scale, but are drawn to emphasize specific features relevant to the invention. Like reference characters denote like elements throughout the figures and text.

### DETAILED DESCRIPTION OF THE INVENTION

Unless defined otherwise, all technical and scientific terms used herein have the same meaning as commonly understood by one of ordinary skill in the art to which this invention pertains. Although any methods and materials similar or equivalent to those described herein can be used in the practice or testing of the invention, the preferred methods and materials are now described. All publications mentioned herein are incorporated herein by reference.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Reference throughout this specification to “one embodiment”, “an embodiment,” “an example embodiment,” means that a particular feature, structure, or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may.

Furthermore, the features, structures or characteristics may be combined in any suitable manner, as would be apparent to a person skilled in the art of this disclosure, in one or more embodiments. Furthermore, while some embodiments described herein include some, but not other features included in other embodiments, combinations of features of different embodiments are meant to be within the scope of the invention. For example, in the appended claims, any of the claimed embodiments can be used in any combination.

In contrast to the described prior art, the present invention optimizes data delivery relative to a schedule by decoupling delivery time from playout time (i.e., scheduling data/media delivery prior to a scheduled playout time thus providing a smooth consumer media experience). The difference here is that consumption (or playout) is pre-determined. The invention does not relate to data or media delivered with an option to ‘watch later’. This invention relates to delivery optimization only, with no consideration for what happens next.

As used herein, ‘data’ includes media content (audio, video, and audiovisual segments/streams) and non-media payloads. The terms ‘data’ and ‘content’ may be used interchangeably where appropriate.

As used herein, “scheduled time of use” refers to a time at which a distribution destination requires data to be available for scheduled play out or service delivery.

As used herein, the phrase “cache accessible to a destination” includes caches located at the destination or at an intermediary node(s) serving the destination.

Thus, a need exists for a system that dynamically prioritizes content delivery based on various pertinent factors, such as:
Delivery schedule: Aligning content delivery with a playout schedule for linear destinations ensures timely delivery and eliminates redundancy in transmission. The general term for this situation is “scheduled time of use”.
Content priority: Emergency alerts, critical communications, and high-value live events may require prioritized delivery with priority over the delivery of less time-sensitive media content.
Caching availability: Efficient utilization of cache associated with a destination, including a cache located at the destination, at an aggregation point serving the destination, or at an intermediary node reachable by the destination without retrieving the data from the origin significantly reduces transmission costs while providing a transparent user experience that compares favorably to traditional fixed delivery systems.
Delivery cost: The system intelligently selects the most cost-effective delivery path, considering network bandwidth costs and network reach (the number of end devices, systems, or software processes that can be reached by the network). In some embodiments, delivery path selection is constrained by the remaining time until the scheduled time of use such that live content is delivered with low latency while non-live content may be delivered earlier to exploit lower-cost or less-congested network windows.

The system comprises a delivery optimization control plan, receiving content schedules and network parameters and generating delivery plans specifying delivery timing and delivery methods. Receiving endpoints report cache availability and delivery readiness, but do not perform reconstruction or play out as part of this invention.

The present invention comprises: (i) a delivery optimization control plan that generates routing and delivery schedules based on content attributes and network parameters, and (ii) distributed destination endpoints that report cache and readiness status and receive content according to the generated delivery schedules.

Note that receiver-side reconstruction, reassembly, and playout timing of the media content are assumed capabilities and are not the subject of this disclosure. Those actions may be implemented by various systems, such as those described in commonly-owned U.S. Pat. No. 12,470,776.

The system of the invention first receives parameters, by way of automated or manual input, that describe the attributes of the data to be delivered. For each media or data stream, the attributes may contain any or all of, but not limited to: a delivery schedule, a delivery priority, and destinations to receive the data.

The present invention analyzes the media/data/content and its attributes, together with known parameters of the delivery networks that will carry the data. Those parameters may include but not limited to: network performance (both historical and predictive), network reach to the destinations, and the cost of network utilization.

Based on this data, at least two new schedules are created:
(i) a routing schedule describing available data delivery paths between the data source and the data destination, and
(ii) a delivery schedule defining when delivery must be completed relative to a scheduled time of use at the receiver. This delivery schedule may be independent of when the user actually consumes the media/data/content.

A delivery schedule defines the latest time by which delivery obligations must be satisfied relative to a scheduled time of use at a destination. In linear distribution, the scheduled time of use corresponds to the destination's playout schedule (wall-clock time). In non-linear distribution, the scheduled time of use may correspond to a defined deadline such as a request time, validity window, or service-level objective.

If the data requires transformation from its original form prior to play back at the destination (e.g. to execute error detection and correction or to decrypt an encrypted data stream), then an additional step (and additional time) is required at the receiver to ensure accurate transformation of the data back to a viewing format.

The delivery schedule includes routing information required to deliver each data packet through the networks to the destination.

The delivery schedule also identifies when delivery obligations must be satisfied at a destination, including immediate deliveries, timing of future deliveries, and deliveries that can be satisfied by using cached data.

When data is already available in a cache, the delivery obligation is considered satisfied, thereby avoiding retransmission across the network.

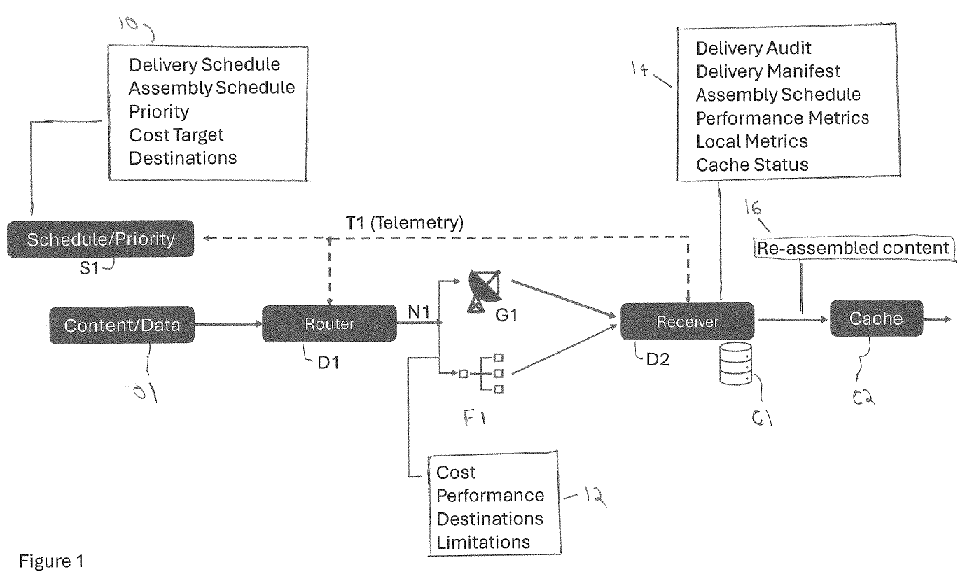

A delivery/priority schedule S1 (see FIG. 1) is generated for each data object, including a media stream, segment collection, file, or other addressable unit of delivery.

Scheduling considerations include (see block 10), but are not necessarily limited to: delivery priority, delivery of live content in near real time, schedule adaptation for destination time zones, number of delivery destinations, time required for reassembling the data at the destination prior to viewing, target delivery time, content of the data, and a cost target.

Content/data/data objects O1 is input to a content analysis module and router D1 in FIG. 1.

The content analysis module D1 (also referred to as a network evaluation module) analyzes incoming data and assigns scheduling priority levels based on predefined criteria including the scheduling considerations set forth above and additional criteria as set forth below, such as:
Content Type: Emergency alerts, live events, pre-recorded content.
Metadata: Content importance tags, scheduled airtime, business rules related to display availability, and regulatory requirements.
Real-time Network Conditions: Network congestion, satellite link availability.
Commonality/fan-out: Whether the data object is required by many destinations (e.g., shared ads, promos, commonly scheduled assets), which may favor multicast/broadcast delivery and caching.

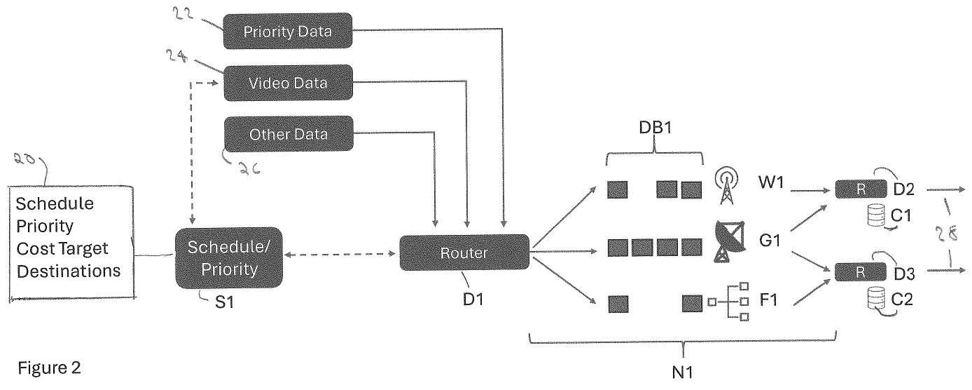

The network evaluation module or router D1 also assesses the available content delivery paths N1 (see FIG. 1), which may comprise, satellite networks G1 (including a geosynchronous satellite network), terrestrial IP networks F1, and wireless cellular networks W1 (not shown in FIG. 1, see FIG. 2) and other available networks not depicted.

The router D1 also considers the associated costs and performance levels (see block 12, FIG. 1) of each possible data path. For instance, the satellite (G1) has a very high delivery cost when measured by the cost of data uploaded, but a very low delivery cost if the data is delivered to a large number of destinations. A traditional internet network may have a very low cost for data delivered to individual destinations, but with significant number of destinations the cost rises dramatically.

A delivery decision (DB1) (see FIG. 2) is assigned to each data object (e.g., data stream, segment set, file). Based on efficiency and cost considerations, the delivery path may be implemented by transmitting packets associated with the data object over one or more selected paths and over one or more network technologies.

Additional cost considerations include:
Bandwidth Costs: Data transfer costs per network type.
Satellite Link Costs: Transponder usage, signal uplink/downlink costs.
Terrestrial Network Costs: IP transit costs, peering agreements.
End point availability: Whether a specific destination is currently connected to an available network.
Destination Cache: If the data object(s) already exist in a destination path they Have an effective delivery cost of zero.

Caching considerations and optimization of the delivery plan also affect data delivery costs and routes.
Caching modules C1 (see FIG. 1) and D2/C1, D3/C2 (see FIG. 2) determine content caching strategies based on data priority, delivery schedule, data re-use, storage/caching availability, network conditions, and network cost.
Content with high priority, frequent scheduled deliveries, or anticipated high demand may be cached at multiple network locations or at multiple receivers for faster access and reduced network load.
Content with low priority and anticipated high demand can be delivered over a longer time span provided it is available at the destination when needed. For example, frequently reused advertising assets scheduled for later playout may be delivered hours in advance during off-peak periods and cached at multiple destinations, while still meeting the scheduled time of use.

Note that selection of a data delivery path is dynamic and can be changed as conditions merit.

The routing decision module D1 in FIGS. 1 and 2 selects the current optimal delivery method and network path N1 based on delivery schedule, delivery cost, priority, cache availability, etc. for each data object based on the combined analysis of (but not limited to):
Content Priority
Delivery Schedule
Network Cost
Destination Cache Availability
See block 10 in FIG. 1 for additional considerations

The data may be delivered over multiple network paths T1, G1, F1 (see FIG. 2) for redundancy.

The system controller/scheduler/controller S1 in FIG. 1 may choose not to deliver data or to deliver substitute data based on an attribute in the schedule. For example, if the system delivers data supporting a webpage reporting weather conditions, the last delivered temperature update in cache C1 or C2 may be utilized until the next weather update is available at the receiver D2 or D3.

After determination of the preferred delivery path, as described herein, the selected data delivery path is utilized to transmit the data to the destination(s).

At a destination, a receiving endpoint (D2 in FIG. 1 and D2 and D3 in FIG. 2) receives delivered data and stores it in an associated cache for scheduled use. The endpoint may perform error detection/correction and decryption as required to render the delivered data usable. Receiver-side reconstruction and playout scheduling are assumed capabilities and are not the subject of this disclosure.

At the receiving destination D2 (receiver) various functions are performed as set forth in block 14 of FIG. 1. The data may be cached at C1

From the receiver D2 the data objects (re-assembled content 16) may retransmitted to another cache C2 and then to other destinations not shown.

FIG. 1 also illustrates paths for telemetry (T1) information that is exchanged between the various components of FIG. 1 for monitoring and analyzing performance of the various network available for carrying media content. This information is important for determining efficient and low-cost network paths through which the media content can be delivered.

With reference to FIG. 2, various parameters that are considered are shown in a block 20. Inputs to a scheduling priority component S1 include priority data 22, video data 24, and other data 26 are input to not only the scheduling priority component S1, but also a router D1 for determining cost-effective data paths for the media content to traverse.

Delivery decisions DB1 that are made by the router D1 include, sending media content over networks N1, including a wireless network W1, a satellite network G1, and a terrestrial internet network F1. Receivers D2 and D3 receive the media content from one or more of the identified networks and cache the media content in respective caches C1 and C2. As depicted by arrowheads 28, the data received at receivers D2 and D3 and cached at cache is C1 and C2 may be retransmitted on another network to other receivers not shown in FIG. 2.

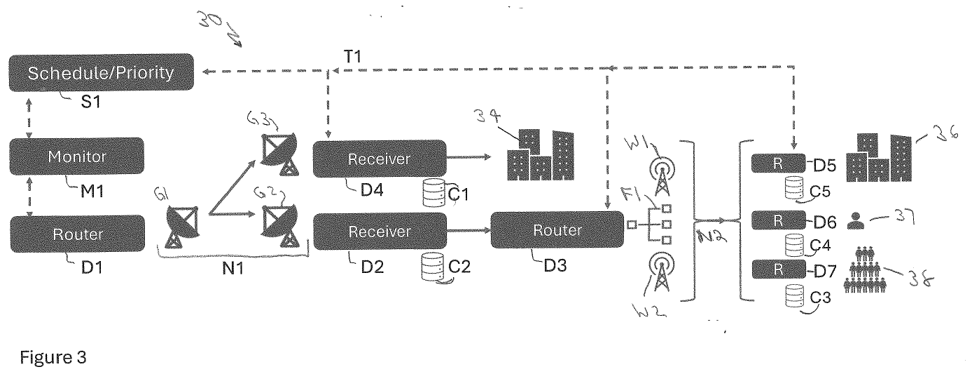

FIG. 3 illustrates an exemplary multi-tier distribution network 30 for distributing the media content to consumers. A schedule/priority component S1 interfaces with various receivers D4, D5, D6, and D7 and router D3 to assign network paths for the media content at each receiver and router on the network 30.

A monitor M1 monitors network conditions and interfaces with router D1 and schedule priority component S1 to identify and assign preferred network paths. From the router D1 the media content progresses to a network N1 comprising satellite terminals G1, G2, and G3.

Satellite terminal G3 provides data to a receiver D4 and satellite terminal G2 provides data to a receiver D2. Caches C1 and C2 are associated with respective receivers D4 and D2. From receiver D4 the media content is sent along to consumers illustrated by buildings 34. From the receiver D2 the media content progresses to a router D3, which further sends the data to a network N2, comprising wireless antennas representing wireless networks W1 and W2 and a terrestrial network F1

Data from one or more of the various components of the network N2 is sent to receiver D5, to receiver D6, and to receiver D7. Each receiver D5, D6, and D7 is coupled to a respective cache C5, C6, and C7 for storing the media content.

The receiver D5 supplies the media content to consumers represented by buildings 36.

The receiver D6 supplies the media content to an individual consumer 37. The receiver D7 supplies the media content to a plurality of consumes 38.

Many of the system advantages are described in the technical descriptions presented above. These advantages include at least:
Reduced Data Delivery Costs: By optimizing for cost-effective data delivery paths N1 and leveraging caching C1-C5, the system significantly reduces overall data transmission expenses. Additionally, by having more data available at the receiver cache D2, C1-C5, closer to the destination, the need for expensive redundancy solutions is largely eliminated.
By completing delivery obligations in advance of scheduled use of the content, the system reduces reliance on real-time delivery and eliminates the need for parallel redundant networks.
Data delivery decisions are dynamic and not absolute as sometimes cached data can be substituted. For example, if the system delivers data supporting a webpage for weather conditions, the last delivered temperature update may be used until the next update is available for delivery.
The system enhances data availability by prioritizing data delivery to ensure that the critical data reaches its destination with minimal latency, improving user experience and supporting time-sensitive applications. For example, if data to be delivered requires real-time updating the priority for all data sources S1 can be appropriately adjusted and the path selection is based on a lowest end to end latency.
The system offers increased scalability and flexibility and can adapt to diverse network environments and data delivery requirements, enabling scalability for future growth and accommodating evolving media consumption patterns. For example, the system can be deployed in a chained configuration where performance of a first network is enhanced by combining it with a second network with different performance characteristics. See FIG. 3
Preferably, at least two schedules are generated: (i) a routing schedule describing available delivery paths, and (ii) a delivery schedule defining when delivery obligations must be satisfied relative to the scheduled time of use, independent of consumption timing.
If data is already present in a cache accessible to a destination, the delivery obligation is considered satisfied, thereby avoiding retransmission. Cached availability may satisfy delivery requirements hours or days prior to scheduled use.
Delivery methods are selected based on delivery cost, number of destinations, cache availability, and time remaining until scheduled use. Live or time sensitive data or media content may be delivered with low latency, while non-live data may be delivered during off peak periods.
Monitoring validates delivery plan fulfillment by tracking cache readiness and delivery status prior to scheduled use. Exception notifications are generated when delivery readiness deviates from the plan and in response thereto the network data paths may be altered.
Receiving endpoints receive delivered data and store it for scheduled use. Receiver-side reconstruction, reassembly, and play out scheduling are assumed capabilities and are not claimed herein.
By completing delivery obligations in advance of scheduled use, the system reduces reliance on-time delivery, eliminates parallel redundancy, lowers delivery cost, and improves reliability across hybrid networks.

Potential applications for the system of the present invention are many and varied, with use for video and radio distribution. government and military communications, emergency alert systems, distance learning and telehealth platforms, and content delivery networks (CDNs).

This invention leverages the information from multiple sources to provide a novel and non-obvious approach to data delivery optimization. The outlined system intelligently routes data over hybrid networks, considering data priority, caching, cost of delivery, and the delivery schedule. By addressing the limitations of traditional data delivery systems, this invention offers a more efficient, cost-effective, and adaptable solution for the evolving media landscape.

What is claimed is:

1. A method for optimizing delivery of data over hybrid networks to a plurality of destinations, the method comprising:
determining a scheduled time of use for the data at each one of the plurality of destinations;
evaluating available delivery networks based on one or more of cost, network reach, and network performance;
determining whether the data is available in a network cache and can be retrieved from the cache and supplied to a destination;
generating a delivery plan specifying a delivery path and a delivery time relative to the scheduled time of use for the data at each one of the plurality of destinations;
delivering the data to each one of the plurality of destinations according to the delivery plan; and
determining that a delivery obligation to a destination has been satisfied when the data is available at the destination or cached prior to the scheduled time of use at the destination.

2. The method of claim 1, wherein delivering the data during a time of reduced network cost and prior to the scheduled time of use.

3. The method of claim 1, wherein a multicast delivery method is selected when the number of destinations exceeds a predetermined threshold.

4. The method of claim 1, wherein delivery to a destination is omitted when the data is present in a destination cache.

5. The method of claim 1, wherein delivery priority is increased for live or time-sensitive data.

6. The method of claim 1, wherein the data is ingested as a single linear stream and replicated to multiple destinations by the system.

7. The method of claim 1, further comprising monitoring delivery readiness and generating an alert when delivery readiness deviates from the delivery plan.

8. The method of claim 1, wherein the delivery networks comprise a terrestrial broadcast network, an internet, a satellite broadcast network, and a cellular network.

9. The method of claim 1, wherein the data comprises audio content, video content, audio/video content, or data.

10. The method of claim 1, further comprising determining a quality of the data as received at a destination.

11. The method of claim 1, wherein network performance comprises one or more of historical, current, and predictive performance.

12. The method of claim 1, wherein a step of evaluating available delivery networks is further based on a schedule for assembling the data at a destination, data priority, cost as compared to cost targets, and a number of destinations to receive the data.

13. The method of claim 1, further comprising determining a status of each cache on the hybrid networks.

14. The method of claim 1, further comprising reassembling the data at a destination.

15. A system for optimizing delivery of data over hybrid networks, comprising:
a delivery optimization module configured to generate delivery plans derived from delivery schedules at each one of a plurality of destinations;
a network evaluation module configured to compare delivery cost and network reach across multiple networks; and
a monitoring module configured to validate delivery plan fulfillment prior to scheduled use of the data.

16. The system of claim 15, wherein the hybrid networks comprise terrestrial IP networks, satellite networks, and wireless networks.

17. The system of claim 15, the hybrid networks comprising a plurality of caches each cache for storing data prior to arrival at one of the plurality of destinations.
